(19) United States
(12) Patent Application Publication
(10) Pub. No.: US 2004/0026003 A1
(43) Pub. Date: Feb. 12, 2004

(54) Radically polymerising mass with improved adhesion to mineral bases and use thereof as an adhesive and sealing mass

(76) Inventors: Roland Dux, Spreitenbach (CH); Fabio Wurmli, Thalwil (CH); Mario Rittiner, Simplon-Dorf (CH)

Correspondence Address: Oliff & Berridge, PO Box 19928, Alexandria, VA, 22320, US

(21) Appl. No.: 10/416,453

(22) PCT Filed: Nov. 26, 2001
(86) PCT No.: PCT/IB01/02233

(30) Foreign Application Priority Data
Nov. 27, 2000 (EP) 00125885.4

(51) Int. Cl. C09J 5/00; C08L 31/00

(52) U.S. Cl. 156/60; 526/319; 524/556

(57) ABSTRACT

Described is a radically curable composition apt particularly as adhesive and sealant and especially for use on damp mineral bases. It features monomers and oligomers of different hydrophilicity/-phobicity in specific proportions.

### REFERENCE TO RELATED APPLICATIONS

This present application claims the priority of European Patent Application No. 00 125 885.4, filed Nov. 27, 2000, whose disclosure content is included here by reference.

### TECHNICAL FIELD

The present invention relates to radically polymerizable masses, especially to masses with good adhesion even to damp mineral bases.

State of the Art

Adhesive bonds and seals in construction and civil engineering require permanent good adhesion to mineral bases. A special position among these bases is occupied by concrete. Since in these fields of application in many cases the substrates are damp and following application are often exposed to direct contact with water, in some cases for a relatively long time, great importance is attached on the one hand to the initial adhesion to damp concrete but also on the other hand to the long-term adhesion under water. Both a rapid cure and a cure at low temperatures are of economic interest, since on the one hand the working times and waiting times can be reduced and on the other hand construction projects do not lead to prolonged delays owing to seasonal cold spells. A further increasingly important aspect in construction and civil engineering is that of ecology.

Binders based on epoxy resin are known to exhibit extremely good adhesion and also excellent long-term stability on mineral bases. Epoxy-resin-based systems, however, are limited in that, on the one hand, a rapid cure at room temperature (i.e., with acceptable initial strengths within less than 15 minutes) is not possible. On the other hand, impaired mechanical properties are evident in the case of low-temperature curing. Moreover, the amines and mercaptans used in such hardeners lead to a severe odor nuisance, which is disadvantageous for the application.

Other binder systems for rapid adhesion systems are based on polyurethanes, polyesters, and methyl methacrylates, all of which, however, are encumbered by disadvantages. Polyurethanes cannot be used without primers, owing to the sensitivity of isocyanates to water on damp mineral bases. Unsaturated polyesters have long been known as rapid binders for adhesives and coatings, but contain styrene (often termed “monostyrene”). Besides the strong inherent odor of styrene, its suspected carcinogenicity and also the low flash point (32° C.) mean that its use cannot be recommended, from the standpoints of occupational hygiene and of safety. Furthermore, binders for rapid adhesive and coating systems based on methyl methacrylate have been known for a long time. Existing methyl methacrylate systems are notable on the one hand for a disruptive inherent odor and also an extremely high contraction on reaction; on the other hand, the adhesion to damp mineral bases is deficient.

Hydrophilic (meth)acrylates, especially hydroxyalkyl (meth)acrylates, or aqueous solutions of these monomers, have already been used for a long time to stabilize soils and rock formations. As typical examples of this mention may be made of GB 1 335 714 and GB 1 303 456. Although excellent initial adhesion on damp mineral bases can be achieved, such binders are unsuitable for adhesives and coatings, since it is possible to ascertain an increased water absorption and also an adhesive failure following prolonged exposure to water.

It is likewise already known that an excessive fraction of hydrophilic units leads to high water absorption and hence to a rapid reduction in strength and in adhesion, and is explained in the literature, for example, “Adhesives in civil engineering, Ed. G. C. Mays, Cambridge University Press, 1992, by the plasticizer effect of the water.

One possibility of hydrophobicization is described in patent EP 0 157 596, which relates to an impregnation system composed of a hydroxyalkyl acrylate/dicyclopentenyloxyalkyl acrylate mixture and fatty acids. The concrete bases provided with such a hydrophobicized impregnation system exhibit a markedly reduced water absorption and stability. The function of an impregnation system, however, is not so much as to ensure an adhesive bond as, primarily, to have a barrier effect and hence to protect the substrate against water and aggressive constituents dissolved therein. In the case of an impregnation system it is desirable for the hydrophobic constituents to be accumulated at the surface, so that migration of the fatty acids-to the surface does not constitute a problem, whereas in the case of an adhesive or a coating this can lead to adhesion problems.

Among the hydrophobic monomers and oligomers a special significance is accorded to the epoxy acrylates. By epoxy acrylates are commonly meant the reaction products of acrylic or methacrylic acid with compounds containing epoxy groups and/or alcohols which can be used for the preparation of compounds containing epoxy groups. The use of epoxy acrylates as adhesives is widely described in the patent literature. One important area of their use lies in the field of plugging compounds and chemical anchorages. EP 0 199 671, DE 36 17 702 and U.S. Pat. No. 4,729,696 all describe 2-component adhesives for chemical fastening which contain epoxy acrylates, but in order to reduce viscosity always in combination with a reactive diluent, such as styrene or methyl methacrylate, for example, or else with isobutyl or isopropyl methacrylate (DE 36 17 702). The reactive diluents listed all have a low flash point, which can lead to safety risks during application and storage. Moreover, the compositions described in the cited patents are not suitable as adhesive or coating systems for mineral substrates, especially for damp concrete after lasting exposure to water.

EP 0 534 201 relates to an alkoxylated epoxy acrylate, with the advantage that, owing to the alkoxylation, a low-viscosity product is obtained which makes it possible to forgo the use of reactive diluents such as styrene or methyl methacrylate. An adhesive formulated on this basis, however, exhibits poor adhesion to the damp concrete.

The use of cycloaliphatic (meth)acrylates, especially dicyclopentadienyl (meth)acrylate or dicyclopentadienyloxyethyl (meth)acrylate, in plugging compounds for example, is known (see for example also EP 0 431 302, EP 0 742 264 and U.S. Pat. No. 5,256,723). The compositions according to the abovementioned patent documents, however, exhibit poor adhesion to damp concrete. Dicyclopentadienyl (meth)acrylate has the great disadvantage of having a penetratingly disruptive odor, severely restricting the use of this monomer. Dicyclopentadiene, which forms the starting material for dicyclopentadienyl (meth)acrylate and for dicyclopentadienyloxyethyl (meth)acrylate, is likewise strongly odorant, has a low flash point, and is toxic, leading to problems and additional complexity in the production of these monomers.

JP 11 106 453 describes a binder which can be used diversely, inter alia for the restoration of concrete. This binder contains epoxy (meth)acrylate, hydroxy (meth)alkyl acrylate, and also, mandatorily, dicyclopentadienyloxyalkylene (meth)acrylate and is notable for low sensitivity to alkaline media, reduced water absorption, and good stability at elevated temperatures; however, the wet adhesion is poor.

Urethane acrylates, which are prepared by reacting isocyanates with a hydroxyalkyl (meth)acrylate, are used in many cases, since they allow the mechanical properties to be varied with ease. According to patent applications EP 0 432 087 and EP 0 589 831 such urethane acrylates are used in combination with reactive diluents such as styrene or other (meth)acrylates. Owing to the necessary use of isocyanates, the preparation of the urethane (meth)acrylates is associated with a high health risk in production. An alcohol is reacted with an isocyanate at elevated temperature in a complicated reaction. It is known, however, that (meth)acrylates tend to undergo spontaneous polymerization at elevated temperature, with large quantities of energy being released within a short time. Consequently, the preparation of urethane acrylates entails an operating risk. The need for protective measures and equipment results in a high extra expense. EP 0 589 831 discloses a combination of epoxy acrylates and/or urethane acrylates with inorganic binders and, if desired, reactive diluent, hydroxyalkyl (meth)acrylate among others. Cements, which in this case constitute the preferred hydraulically setting binders, are, however, very basic and therefore constitute a hazard potential in contact with the skin, meaning that omitting cement is advantageous. Moreover, owing to the homogeneous distribution of the cement, there is an inherent risk of saponification of the acrylate matrix.

It is known-that the use of silanes leads to an improvement (under the effect of water) in the adhesion of certain adhesives on diverse bases. In particular, the mode of action and use of silanes in epoxides and polyurethanes on glass and metals is documented in the literature. As an example thereof mention may be made of the works of Plueddemann (Plueddemann E. P. in “Silane Coupling Agents”, Plenum Press, New York 1991 and Plueddemann E. P. in “Silanes and other Coupling Agents”, Ed. Mital K. L., VSP, Utrecht 1992).

For improving the adhesion of acrylic emulsions to mineral bases EP 0 587 332 mentions adding zinc oxide. U.S. Pat. No. 4,122,074 describes a polyesteraminoalkylalkoxysilane which can be prepared by Michael Addition of an amino-functional silane with an unsaturated conjugated polyester and which can be employed as an adhesion promoter. The use of an amino-functional silane in acrylates is critical, however, since the storage stability is considered problematic. EP 0 327 376 describes the preparation of a copolymer of vinyl ester and silicon-containing monomers. The binders for emulsion coatings that are prepared from said copolymer show a great improvement in abrasion resistance as compared with silane-free formulations. Mentioned as being of specific suitability are copolymers of vinyl acetate and vinyltrimethoxysilane or methacryloyloxyethyltrimethoxysilane. Emulsion polymers have improved abrasion resistance if—as claimed in EP373866—an emulsion polymer is used whose preparation includes, in a second step, an afterreaction of epoxysilanes with a vinyl ester emulsion. FR 2 615 197 shows that a coating based on polymethyl methacrylate adheres excellently to mineral bases if said bases have been treated beforehand with aqueous silane primers.

JP 10 297 982 describes a concrete primer for concrete repair that comprises, in addition to 2.5-30% by weight of an unsaturated alkoxysilane, 60-90% by weight of an unsaturated epoxyester resin, 2.5-30% by weight of a hydroxy-functional (meth)acrylate monomer, and, preferably, a solvent having a boiling point of less than 120° C. Such a high silane content is poor for ensuring reliable initial adhesion, particularly in the case of highly filled systems on damp concrete.

The adhesion of customary (meth)acrylate-based polymers on damp mineral bases, especially concrete, is poor. This is true in particular for the long-term adhesion after water storage. Good initial adhesion on damp bases of this kind can be achieved with monomers having hydrophilic properties, such as hydroxyethyl (meth)acrylate or hydroxypropyl (meth)acrylate, for example. Polymers resulting from hydrophilic monomers of this kind, however, absorb water strongly when stored in water, leading to a reduction in the intrinsic strength on the one hand and in the adhesion to the base on the other.

Polymers which result from hydrophobic (meth)acrylate monomers and/or oligomers generally exhibit poor initial adhesion to mineral substrates, especially damp concrete.

It is therefore desirable to have a polymer with both good initial adhesion and good ultimate adhesion and intrinsic strength.

### DESCRIPTION OF THE INVENTION

Surprisingly it has now been found that through the combination of (meth)acrylate monomers and/or oligomers differing in hydrophilicity or hydrophobicity in certain proportions it is possible to achieve an improvement in the initial adhesion to damp mineral bases, especially concrete, and in the long-term adhesion after water storage. This effect, especially at relatively high temperatures, is intensified further by the addition of silanes.

By selecting the monomers classified below as more hydrophobic it is possible to control the crosslinking density and hence also the mechanical properties. Thus, for example, rigid difunctional monomers and oligomers lead to rigid systems of high strength, while monofunctional aliphatic monomers lead to soft and flexible systems.

A rapid cure at room temperature is worth aiming at for many applications, since with rapid bonding complicated fixing of the adherents is no longer necessary and forces can be transmitted quickly. In the case of coatings and undercoats, a rapid cure prevents damage to the surface and/or permits rapid overcoatability. All of these properties are of extremely great financial advantage, since the use of a rapid-curing adhesive, sealant or coating allows reductions in work times and down time.

Although it is also possible to shorten the cure time by supplying heat, e.g., by heating using thermal sources or IR radiation, this is in many cases not an option in construction and civil engineering.

The present invention accordingly provides in particular a radically curable composition which is characterized in that it comprises or consists of a mixture of monomers and/or oligomers of different hydrophilicity or hydrophobicity in particular proportions.

A radically curable composition of the invention comprises or consists of:

a) 31-60% by weight of at least one hydroxyalkyl (meth)acrylate of the formula A,

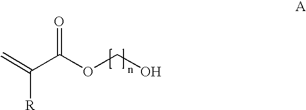

in which

R=H, CH₃, and

n=2-4, preferably 3 or 4, and

b) 40-70% by weight of at least one monomer and/or oligomer B selected from the group consisting of the following substances B-1, B-2, B-3, and B-4 or mixtures thereof, where

b-1) denotes compounds of the formula B-1

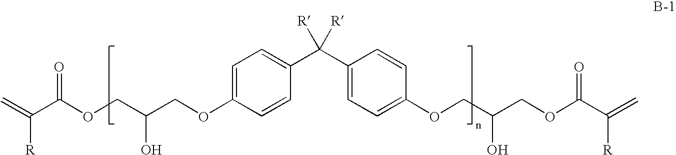

in which

R=H, CH₃,

R′=H, CH₃, and

n=1 or 2,

b-2) denotes compounds of the formula B-2

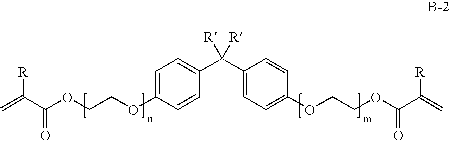

in which

R=H, CH₃,

R′=H, CH₃,

n=1-3, and

m=1-3,

b-3) denotes difunctional alkylene di(meth)acrylates B-3, in particular difunctional alkylene di(meth)acrylates of the following formula B-3′

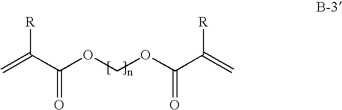

in which

R=H, CH₃, and

n=2-6, and

b-4) denotes monofunctional alkyl (meth)acrylates B-4, the monofunctional alkyl (meth)acrylates preferably having the following formula B-4′

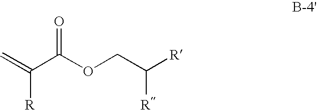

in which

R=H or CH₃,

R′=H or (CH₂)ₙCH₃ with n=0-2, in particular CH₂CH₃, and

R″=C₃-C₂₀ alkyl or phenoxy or O—(CH₂)ₙ—CH₃ with n=0-2, in particular (CH₂)₃CH₃,

the sum of the weight percentages of A+B having been set at 100% by weight and the sum of the percentages by weight of B-1+B-2 is 0-20% by weight, the amount of B-3 is 0-45% by weight, and the amount of B-4 is 0-65% by weight. The compounds A are more hydrophilic than the compounds B-1 to B-4, which is why the compounds A are also referred to as hydrophilic components and the compounds B-1 to B-4 as hydrophobic components. Preferably at least one of the compounds B-1, B-2 and/or B-3 is present. The sum of B-1+B-2+B-3 is normally in the range from >0 to 65% by weight, preferably in the range from 10 to 65% by weight, in particular in the range from 30 to 65% by weight, and with special preference around 60% by weight.

Where appropriate the composition of the invention may further comprise adhesion promoters C, especially silanes, preferably 3-mercaptopropyltrimethoxysilane, (3-methacryloyloxypropyl)trimethoxysilane, and 3-glycidyloxypropyltrimethoxysilane or the triethoxy compounds thereof, and/or accelerators D, the normal amount of C being 1-10% by weight and the amount of D being 0.5-5% by weight based in each case on A+B=100% by weight.

It has been found advantageous if such radically curable compositions contain no hydraulically setting and/or polycondensable inorganic additions, such as cement, gypsum, waterglass, etc. Setting additions of this kind may adversely affect the long-term stability.

Ways of Performing the Invention

In order to ensure reliable initial adhesion, particularly in the case of highly filled systems on damp concrete, the composition of the invention comprises, at 31 to 60% by weight, a relatively high hydroxyalkyl (methacrylate) content and, at 0-20% by weight, a relatively low epoxy acrylate content. For further hydrophobicization further monomers (B-3 and/or B-4) are admixed to the composition of the invention, especially readily available, inexpensive monomers. The mixture further contains not more than 10% by weight of silanes, which is likewise beneficial to the initial adhesion, while any solvent, which might have an adverse effect on the initial strength, is omitted.

The reactive composition of the invention is, consequently, free from solvents and strongly odorant substances such as, in particular, styrene and methyl methacrylate. It is toxicologically advantageous and possesses a good adhesive spectrum, so that there is no need for pretreatment by means of primer.

As a result of the hydroxyalkyl (meth)acrylate, which represents a central constituent of the composition of the invention, the reactive composition of the invention possesses an excellent wet adhesion.

As already mentioned, it is possible to include adhesion promoters, especially silanes, in the composition of the invention. The improvement in adhesion is manifested within a short time at elevated temperatures and cataplasm conditions (100% relative humidity, 70° C.).

The selection and the amount of the (meth)acrylates referred to as B, and more hydrophobic than A, is dependent on the desired properties of the cured product, within the limits stated. Flexible systems tend to have a greater amount of monofunctional alkyl (meth)acrylates than rigid systems. Moreover, with the composition of the invention, the hydrophobic constituents are bound in the matrix, thereby preventing separation or migration after curing.

In order to accelerate the reaction it is preferred to use an activator. Suitable activators are known to the skilled worker. Nonlimiting examples that may be mentioned include the following: tertiary amines such as N,N-dimethylaniline, N,N-dimethyltoluidine, N,N-diethylaniline, N,N-diethyltoluidine, N,N-bis(2-hydroxyethyl)-p-toluidine, ethoxylated p-toluidines, N,N-bis(2-hydroxyethyl)-p-toluidine, etc.

It is also possible to add salts or complexes of the transition metals, in particular of cobalt, nickel, and copper.

The composition of the invention can be cured by free radicals. For curing, one or more reaction initiators are used. Suitable initiators are known from the prior art. Of special suitability are organic peroxides: benzoyl peroxide is preferred.

The presence of additional constituents in the composition, such as plasticizers, additives for influencing the rheology, the removal of air or the potlife, polymerization inhibitors, and organic and inorganic fillers, is possible. The amount of fillers is dependent on the application of the product, since it influences the consistency, which can be from liquid to pastelike. For pastelike systems an amount of fillers of up to 300% by weight is possible, based on the sum of A+B+C+D, i.e., a 75% fill level, although preference is given to fill amounts of between 60% by weight and 240% by weight, i.e., fill levels of 37-70%.

Of importance for adhesives is a thixotropic behavior, which allows vertical application or overhead application and prevents the composition running following the release of pressure from the applicator. It should be ensured, for example, that the composition can be extruded as far as possible by means of manual delivery devices, even at relatively low temperatures (e.g., 5° C.). Moreover, preferred compositions are those which present little resistance to flow in a static mixer.

The reactive composition of the invention can be used for a very wide variety of applications. It is especially suitable for use as an adhesive and sealant, particularly for use in construction and civil engineering. Examples that may be mentioned to this application, but which in no way restrict the invention, include the following: concrete repair mortars, crack injection, substrate stabilization, anchoring of plugs and ferrous reinforcing elements, sewer renovation, adhesive coatings, bridge renovation, etc.

Alternatively the composition of the invention can be used as coating material for protecting a surface, in which case a composition of the invention is admixed with an initiator and then applied directly, i.e., without pretreatment, to the substrate.

In the production of a bond or seal involving at least one mineral substrate, especially damp substrates, particularly concrete, either a layer of a composition of the invention is brought between two substrates in such a way that both substrates are in contact with it or a layer of a composition of the invention is applied to a first substrate, and then a second substrate is applied to the opposite surface of the composition of the invention from the first substrate.

The composition can be applied manually or mechanically: for relatively small applications, manual application devices are preferred, such as 2-component cartridges or multichamber pouches, for example, whereas for larger applications pumps and/or robots may be employed.

The examples set out below are intended to illustrate the invention in more detail without restricting it in any way.

### EXAMPLES

The examples set out in Table 1 below are some possible formulations of compositions of the invention.

The formulations were applied in each case to concrete garden slabs. The concrete slabs were sandblasted beforehand in order to remove any concrete skin present. The slabs were subsequently cleaned with water.

A “dry” garden concrete slab thus prepared had a surface dampness of not more than 2%.

After analogous cleaning the damp concrete slab was stored under water at room temperature for at least 2 weeks. Before use, the water present on the surface of the slab was removed roughly using a cloth. The concrete slab thus prepared had a surface dampness of between 5 and 10% and was used immediately for the application.

TABLE 1
Formulation of the examples

| | | | | | Binder | Binder | Binder | | | |
|---|---|---|---|---|---|---|---|---|---|---|
| Formulation | Example 1 | Example 2 | Example 3 | Example 4 | example 1 | example 2 | example 4 | Example 5 | Example 6 | Example 7 |
| | Filled | filled | filled | filled | unfilled | unfilled | unfilled | unfilled | unfilled | unfilled |
| | Reference | reference | rigid | rigid | reference | reference | rigid | flexible | flexible2 | flexible3 |
| Hydroxypropyl | 100 | | 40 | 40 | 100 | | 40 | 40 | 40 | 40 |
| methacrylate | | | | | | | | | | |
| Epoxy acrylate | | 100 | 15 | 15 | | 100 | 15 | 10 | 10 | 10 |
| Ethylene glycol | | | 45 | 45 | | | 45 | 10 | 5 | |
| dimethacrylate | | | | | | | | | | |
| 2-Ethylhexyl methacrylate | | | | | | | | 40 | 45 | 50 |
| (3- | | | | 3 | | | 3 | 3 | 3 | 3 |
| Methacryloyloxypropyl)- | | | | | | | | | | |
| trimethoxysilane | | | | | | | | | | |
| Coated chalk | 50 | 50 | 50 | 50 | | | | | | |
| Quartz flour | 50 | 50 | 50 | 50 | | | | | | |
| Dimethylaniline | 0.22 | 0.5 | 0.24 | 0.24 | 0.22 | 0.5 | 0.5 | 0.5 | 0.5 | 0.5 |
| Benzoyl peroxide in | 0.5 | 0.42 | 0.42 | 0.42 | 0.5 | 0.42 | 1 | 1 | 1 | 1 |
| plasticizer (40 %) | | | | | | | | | | |

The formulations from Table 1 were applied in a layer thickness of approximately 2 mm. The layer thickness was ensured by means of a self-adhesive tape of this thickness and its subsequent removal.

After the measurement of the tensile adhesion value after 24 hours (corresponding to the initial value in Table 2) the slabs were stored under water at room temperature.

For the measurement of the tensile adhesion value a core hole 3 cm in diameter and about 2 cm deep was drilled. The surface to be bonded was dried off and abraded. Thereafter a steel roundel was attached using a fast-curing methacrylate adhesive and the adhesion was tested using a tensile adhesion apparatus with a pulling speed of approximately 2 mm/min.

For the water absorption, tensile strength dumbbells were produced and the weight increase following underwater storage was determined by means of weighing in comparison to the respective weight prior to water storage.

TABLE 2
Results of the formulation examples

| | | | | | Binder | Binder | Binder | | | |
|---|---|---|---|---|---|---|---|---|---|---|
| Formulation | Example 1 | Example 2 | Example 3 | Example 4 | example 1 | example 2 | example 4 | Example 5 | Example 6 | Example 7 |
| | Filled | filled | filled | filled | unfilled | unfilled | unfilled | unfilled | unfilled | unfilled |
| | Reference | reference | rigid | rigid | reference | reference | rigid | flexible | flexible2 | flexible3 |
| Water absorption after 7 d | 6% | 0.1% | 0.1% | 0.0% | 15% | 0.1% | 0.8% | 0.6% | 0.5% | 0.8% |
| [%] | | | | | | | | | | |
| Water absorption after 14 d | 11% | 0.1% | 0.2% | 0.1% | 19% | 0.1% | 1.5% | 0.9% | 0.8% | 1.1% |
| [%] | | | | | | | | | | |
| Adhesion to dry concrete | | | | | | | | | | |
| [MPa] (amount of | | | | | | | | | | |
| concrete fracture %) | | | | | | | | | | |
| Initial adhesion | 3 | 0.6 | 1.6 | 2.4 | n.a. | n.a. | n.a. | n.a. | n.a. | n.a. |
| | (12%) | (0%) | (37%) | (82%) | | | | | | |
| After water storage: | | | | | | | | | | |
| After 7 d | 2.2 | 0.8 | 4.1 | 4.6 | n.a. | n.a. | n.a. | n.a. | n.a. | n.a. |
| | (36%) | (3%) | (51%) | (75%) | | | | | | |
| After 14 d | 1.7 | 0.6 | 3.5 | 4.6 | n.a. | n.a. | n.a. | n.a. | n.a. | n.a. |
| | (10%) | (0%) | (43%) | (90%) | | | | | | |
| Adhesion to damp | | | | | | | | | | |
| concrete [MPa] | | | | | | | | | | |
| (proportion of concrete | | | | | | | | | | |
| fracture %) | | | | | | | | | | |
| Initial adhesion | 3 | 0 | 1.4 | 2.4 | n.a. | n.a. | n.a. | n.a. | n.a. | n.a. |
| | (50%) | (0%) | (37%) | (91%) | | | | | | |
| After water storage: | | | | | | | | | | |
| After 7 d | 2.3 | 0 | 3.9 | 4.5 | n.a. | n.a. | n.a. | n.a. | n.a. | n.a. |
| | (15%) | (0%) | (61%) | (88%) | | | | | | |
| After 14 d | 1.5 | detached | 2.7 | 4.1 | n.a. | n.a. | n.a. | n.a. | n.a. | n.a. |
| | (10%) | | (10%) | (80%) | | | | | | |

| | | | | | | | | | | |
|---|---|---|---|---|---|---|---|---|---|---|
| Adhesion to damp | | | | | | | | | | |
| concrete [MPa] | | | | | | | | | | |
| (proportion of concrete | | | | | | | | | | |
| fracture %) | | | | | | | | | | |
| Initial adhesion | 3 | n.a. | 1.4 | 2.4 | n.a. | n.a. | n.a. | n.a. | n.a. | n.a. |
| | (50%) | | (37%) | (91%) | | | | | | |
| after 3 d cataplasm | 0.9 | n.a. | 2.5 | 2.9 | n.a. | n.a. | n.a. | n.a. | n.a. | n.a. |
| | (3%) | | (8%) | (48%) | | | | | | |
| After 7 d cataplasm | 0.5 | n.a. | 1.4 | 1.6 | n.a. | n.a. | n.a.. | n.a. | n.a. | n.a. |
| | (0%) | | (6%) | (15%) | | | | | | |
| Tensile strength (MPa) | | | | | | | | | | |
| Initial value | 10 | 10 | 17 | 14 | 34 | n.a. | 35 | 36 | 23 | 10 |
| after l4 d of water | 1 | 10 | 11 | 14 | 1 | n.a. | 7 | 30 | 18 | 10 |
| storage | | | | | | | | | | |
| Elongation at break | | | | | | | | | | |
| [%] | | | | | | | | | | |
| Initial value | 1 | 1 | 1 | 1 | 2 | n.a. | 2 | 8 | 27 | 64 |
| After 14 d of water | 56 | 1 | 0 | 0 | 73 | n.a. | 1 | 14 | 30 | 84 |
| storage | | | | | | | | | | |
| Overall assessment | n.i.o. | n.i.o. | i.o. | i.o. | n.i.o. | n.i.o. | i.o. | i.o. | i.o. | i.o. |

n.i.o.= not in order
n.a.= not analyzed

n.i.o.=not in order

n.a.=not analyzed

From the results of Table 2 it is evident that pure hydroxypropyl acrylate (Example 1) very quickly absorbs large amounts of water and decreases rapidly in tensile strength and in the tensile adhesion strengths.

The fracture pattern of the damp adhesion deteriorates after even short exposure to water very rapidly, and adhesive fracture occurs to an increased extent.

In the case of the pure epoxy acrylate (Example 2) no initial adhesion can be found on damp concrete, but the water absorption after storage is low.

The dry adhesion of the pure epoxy acrylate is at a very low level from the start.

The blend (Example 3) shows that both initial adhesion to damp concrete and long-term adhesion are ensured. In order to see the effect of the silane on the adhesion, Example 4 was carried out. It is found that, with silane, concrete fracture takes place to an increased extent at a higher level. Under the drastic conditions of cataplasm storage (70° C./100% relative atmospheric humidity) it is evident that the formulations of Examples 3 and 4 exhibit high adhesion values with a large proportion of concrete fracture for very much longer in comparison with the formulation of Example 1. The positive effect of the silane is also in evidence here. The measurements under cataplasm conditions serve as a simulation of long-term water storage at room temperature, so that changes are visible at an early stage.

Examples 5 and 6 show that through a careful choice of the hydrophobic monomers it is possible to prepare flexible binders. No further values were measured.

While the present specification describes preferred embodiments of the invention, it should be pointed out clearly that the invention is not restricted

1. (Previously Amended) A radically curable composition, characterized in that it is composed as follows:
a) 31-60% by weight of at least one hydroxyalkyl (meth)acrylate of the formula A, 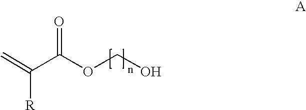
in which
R=H, CH₃, and
n=2-4, preferably 3 or 4, and
b) 40-70% by weight of at least one monomer and/or oligomer B selected from the following substances B-1, B-2, B-3, and B-4 or mixtures thereof, where
b-1) denotes compounds of the formula B-1 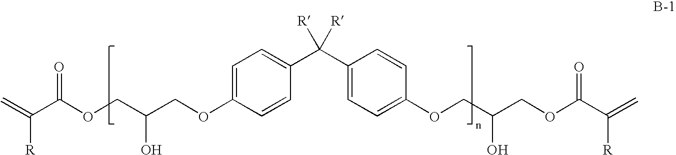
in which
R=H, CH₃,
R′=H, CH₃, and
n=1 or 2,
b-2) denotes compounds of the formula B-2 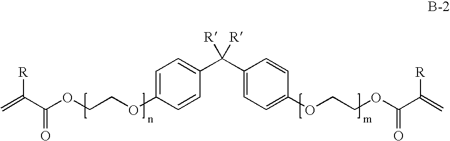
in which
R=H, CH₃,
R′=H, CH₃,
n=1-3, and
m=1-3,
b-3) denotes difunctional alkylene di(meth)acrylates B-3, and
b-4) denotes monofunctional alkyl (meth)acrylates B-4, and
the sum of the weight percentages of A+B having been set at 100% by weight and the sum of the percentages by weight of B-1+B-2 is 0-20% by weight, the amount of B-3 is 0-45% by weight, and the amount of B-4 is 0-65% by weight, and where at least one compound B is selected from the group consisting of B-1, B-2, B-3, and mixtures thereof

2. (Previously Amended) The radically curable composition of claim 1, characterized in that it further comprises a compound B-4.

3. (Currently Amended) The radically curable composition of claim 1 one of the preceding claims, characterized in that B-3 is selected from at least difunctional alkylene di(meth)acrylate of the following formula B-3′ 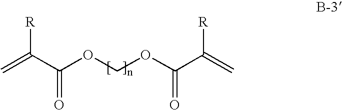
in which
R=H, CH₃ and
n=2-6.

4. (Currently Amended) The radically curable composition of claim 1 one of the preceding claims, characterized in that B-4 is selected from one or more monofunctional alkyl (meth)acrylates of the following formula B-4′ 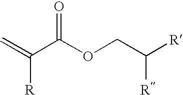
in which
R=H or CH₃,
R′=H or (CH₂)_{N}CH₃ with n=0-2, especially CH₂CH₃, and
R″=C₃-C₂₀ alkyl or phenoxy or O—(CH₂)ₙ—CH₃ with n=0-2, especially (CH₂)₃CH₃.

5. (Currently Amended) The radically curable composition of claim 1 one of the preceding claims, characterized in that it further comprises adhesion promoter C, the amount of C being 1-10% by weight based on A+B=100% by weight.

6. (Previously Amended) The radically curable composition of claim 5, characterized in that the adhesion promoter C is a silane, in particular a silane selected from the following group: 3-mercaptopropyltrimethoxysilane, (3-methacryloyloxypropyl)trimethoxysilane, and 3-glycidyloxypropyltrimethoxysilane or their triethoxy compounds or mixtures of said silanes.

7. (Currently Amended) The radically curable composition of claim 1 one of the preceding claims, characterized in that it further comprises accelerator D, the amount of D being 0.5-5% by weight based on A+B=100% by weight.

8. (Previously Amended) The radically curable composition of claim 7, characterized in that the accelerator D is an activator, in particular a tertiary amine and/or a salt and/or a complex of the transition metals.

9. (Previously Amended) The radically curable composition of claim 8, characterized in that the accelerator D is selected from the group consisting of N,N-dimethylaniline, N,N-dimethyltoluidine, N,N-diethylaniline, N,N-diethyltoluidine, N,N-bis(2-hydroxyethyl)-p-toluidine, ethoxylated p-toluidines, N,N-bis(2-hydroxyethyl)-p-toluidine or mixtures thereof.

10. (Previously Amended) The radically curable composition of claim 8, characterized in that the salts and/or complexes of the transition metals are selected from salts or complexes of the transition metals cobalt, nickel and/or copper.

11. (Currently Amended) The radically curable composition of claim 1 one of the preceding claims, characterized in that for curing it comprises at least one reaction initiator, in particular at least one organic peroxide, with especial preference benzoyl peroxide.

12. (Currently Amended) The radically curable composition of claim 1 one of the preceding claims, characterized in that it comprises additional constituents selected from the group consisting of plasticizers, additives for influencing the rheology, additives for influencing the removal of air, additives for influencing the pot life, polymerization inhibitors, inorganic fillers, organic fillers, and mixtures thereof.

13. (Currently Amended) The radically curable composition of claim 1 one of the preceding claims, characterized in that in addition to the at least one hydroxyalkyl (meth)acrylate of the formula A and at least one compound of the formula B it comprises or consists of at least one accelerator D, at least one reaction initiator, and at least one further compound selected from the group consisting of adhesion promoter C, plasticizer, additive for influencing the rheology, additive for influencing the pot life, organic fillers, inorganic fillers, and mixtures thereof.

14. (Previously Amended) The radically curable composition of claim 13, characterized in that it consists of at least one hydroxyalkyl (meth)acrylate of the formula A and at least one compound of the formula B, at least one accelerator D, at least one reaction initiator, and at least one further compound selected from the group consisting of adhesion promoter C, plasticizer, additive for influencing the rheology, additive for influencing the pot life, organic fillers, inorganic fillers, and mixtures thereof.

15. (Currently Amended) The radically curable composition of claim 13 or 14, characterized in that the at least one further compound comprises or consists of an adhesion promoter C.

16. (Currently Amended) The radically curable composition of claim 13 one of claims 13 to 15, characterized in that the at least one further compound comprises or consists of an additive for influencing the pot life.

17. (Currently Amended) The radically curable composition of claim 13 one of claims 13 to 16, characterized in that the at least one further compound comprises or consists of an additive for influencing the pot life.

18. (Currently Amended) The radically curable composition of claim 13 one of claims 13 to 17, characterized in that the at least one further compound comprises or consists of organic and/or inorganic fillers.

19. (Previously Amended) The radically curable composition of claim 13, characterized in that it consists of at least one hydroxyalkyl (meth)acrylate of the formula A and at least one compound of the formula B, at least one accelerator D, at least one reaction initiator, at least one adhesion promoter C, at least one plasticizer, at least one additive for influencing the rheology, at least one additive for influencing the pot life, and at least one organic and/or inorganic fillers.

20. (Previously Amended) The radically curable composition of claim 13, characterized in that it consists of at least one hydroxyalkyl (meth)acrylate of the formula A and at least one compound of the formula B, at least one accelerator D, at least one reaction initiator, at least one plasticizer, at least one additive for influencing the rheology, at least one additive for influencing the pot life, and at least one organic and/or at least one inorganic filler.

21. (Currently Amended) The radically curable composition of claim 1 one of the preceding claims, characterized in that the sum of B-1+B-2+B-3 is in the range from >0 to 65% by weight, preferably in the range from 10 to 65% by weight, in particular in the range from 30 to 65% by weight, and with especial preference around 60% by weight.

22. (Currently Amended) The use of a radically curable composition of claim 1 one of the preceding claims as a coating material.

23. (Currently Amended) The use of a radically curable composition of claim 1 one of claims 1 to 21 as an adhesive and/or sealant.

24. (Currently Amended) The use of claim 22 or 23 on damp mineral substrates, especially concrete.

25. (Currently Amended) A method of coating a mineral substrate such as concrete, in particular a damp mineral substrate, characterized in that a radically curable composition of claim 1 one of claims 1 to 21 is applied directly, i.e., without pretreatment, to the substrate.

26. (Currently Amended) A method of adhesively bonding or sealing mineral substrates, especially damp substrates, particularly concrete, characterized in that a layer of a radically curable composition of claim 1 one of claims 1 to 21 is brought between two substrates in such a way that both substrates are in contact therewith.

27. (Currently Amended) A method of adhesively bonding or sealing mineral substrates, especially damp substrates, particularly concrete, characterized in that a layer of a radically curable composition of claim 1 one of claim 1 to 21 is applied to a first substrate and in that subsequently a second substrate is applied to the opposite surface of the radically curing composition from the first substrate.
